(19) United States
(12) Patent Application Publication
(10) Pub. No.: US 2017/0013464 A1
(43) Pub. Date: Jan. 12, 2017

(54) METHOD AND A DEVICE TO DETECT AND MANAGE NON LEGITIMATE USE OR THEFT OF A MOBILE COMPUTERIZED DEVICE

(71) Applicants: Gila FISH, Mevasseret Zion (IL); Avner KORMAN, Herzlia (IL)

(72) Inventors: Gila FISH, Mevasseret Zion (IL); Avner KORMAN, Herzlia (IL)

(21) Appl. No.: 14/795,108

(22) Filed: Jul. 9, 2015

(51) Int. Cl. H04W 12/12; H04W 12/06; H04W 12/08

(52) U.S. Cl. CPC H04W 12/12; H04W 12/08; H04W 12/06

(57) ABSTRACT

A method, a device and a system are provided for mobile devices theft protection and for avoiding none legitimate and misuse of the devices. It is based on a human 3D device holding hand movement, while creating a bio-authentication event of a user of the mobile device. In case of authentication failure it activates various types of alarms locally on the device, and/or deactivating or blocking one or more of the device operational functions, like communication or access to certain functions, stored data, or applications and it transmits alarms and illegitimate user images via text and image messages to remote locations. In other cases it generates and transmits also device's status and location to remote user's piers nearby, or to a monitoring center, all based on the user's device authentication failure and following activated action items.

### CROSS REFERENCE TO RELATED APPLICATIONS

This application claims the benefit of U.S. provisional patent application No. 62/022,705 filed on 10 Jul. 2014 and incorporated by reference as if set forth herein.

### FIELD AND BACKGROUND OF INVENTION

The present invention relates to mobile electronic devices non legitimate use, theft or loss protection and in particular to methods, a device configuration and a system for the user's bio authentication and for blocking of any non-legitimate identified user of a mobile electronic device and then generating alarms, wherein unlocking and activating the devise, or locking selected security management functions of the electronic device, are all based on the user's bio authentication process results.

### BACKGROUND

Portable wireless communication equipment, including smart mobile telephones, portable data assistants (PDAs), Notepads, Notebooks and other mobile electronic devices have been available for the common users for several years.

It has been recognized that the high portability of modern portable wireless communication equipment, put such devices at a heightened risk for loss or more to it to theft. More specifically, because such devices are carried through most of the daily activities hours by a person, they are easily lost and easily stolen. Further, such loss or theft put such devices at risk of unauthorized use of the device's communication services, the loss of a costly personal devise containing a large variety of personal information important to its user, and more to it unauthorized access by a hostile intruder to sensitive user's data stored on the device.

To reduce the risk of unauthorized use of the device's communication services and/or unauthorized access to stored data, most portable communication devices includes a password protection system. A typical password protection system is implemented by disabling the keypad, or the telephone circuits, and/or the data applications, unless and until the user enters an applicable unlock code.

Generally the password/unlock code is in the form of alpha numeric text which may be entered using the keypad of the mobile electronic device. There exist several challenges with such alphanumeric password/unlock code protection systems.

First, the protection provided by a password only exists so long as the password is not compromised. Many people tend to use passwords that are easily guessed, write their passwords on paper, and otherwise compromise the integrity of their passwords.

Second, user entry of a password (and the associated key strokes needed to reach the password entry prompt and active the electronic device after password entry) can be time consuming and aggravating—to the point where many people select the option of disabling the password protection of the mobile electronic device.

An alternative system used to password protect a mobile telephone is disclosed in U.S. Pat. No. 6,351,634 to Shin. The system of Shin is useful for a mobile telephone that includes a touch screen. A registered secret symbol is used as the password. The secret symbol comprises a stroke number value responsive to the existence of pressure applied to the touch screen and X/Y coordinate values for each stroke. In operation, a user inputs a symbol using the pressure sensitive touch screen to draw the various strokes of the secret symbol. The device determines whether the input symbol matches the registered secret symbol and unlocks the telephone if the character stroke number value and the X/Y coordinate value signals match that of the secret password symbol. Shin teaches that the secret password symbol can be a character, a signature, a numeral, or a combination thereof.

One challenge with the system of Shin is that it requires that the mobile telephone have a touch sensitive display for free form entry of the symbol. Most mobile telephones do not include a touch sensitive display—making the technology inappropriate for such devices. A second challenge of the system of Shin is that so long as someone can duplicate the secret password symbol, whether by tracing or careful drawing on the touch screen, such person has access to the mobile telephone. Stated another way, authentication of the user is based on the user being able to duplicate the strokes and shape of the secret password symbol.

In a completely separate field of technology, character recognition has been proposed for use as a means for user input of character data into a computer system. For example, U.S. Pat. No. 6,188,392 to O'Connor discloses an electronic pen device that is coupled to a computer system by an RF transmitter or a batch communication docking station. The electronic pen device includes a combination of a pressure sensitive tip (for detecting contact with a surface) and accelerometers for detecting movement of the electronic pen device while in contact with the surface. Data from the accelerometers and the pressure sensitive tip are used to recognize each of a sequence of characters input by the user.

While it may be possible to use the electronic pen device of O'Connor with a mobile telephone, such a system would include several drawbacks. First, such a system would be relatively expensive compared to a traditional mobile telephone or even the mobile telephone of Shin. Such a system would require the need for separate processing systems for both the mobile telephone and the pen, separate batteries, complimentary communication systems (whether by RF or docking station), and other duplicate components. Secondly, use of a discrete external electronic pen with a mobile telephone would be cumbersome at best for a user. The user would need to handle and maintain two separate devices.

The aim of a biometric system is the realization of the identification/authentication of people using some biological characteristic or physically measured behavior of the individual, in a safe and non-invasive way. The problem of identification and authentication of people is very old and has always tried to solved with different media: sealed, titles, nameplates, etc. Today this is not enough and you need to introduce new authentication and identification techniques to ensure that a person is who they say they are in many contexts.

There are many biometric techniques that try to recognize a person by their physical characteristics (iris, face morphology, fingerprint, voice recognition, etc.) or their behavior (gait, manner of writing, online signature, etc.). It is vital in this document, by its similarity, to implement signature by a biometric technique online. Many works have been developed to improve this technique. They explain the basis for online signature verification. In this type of testing, it is compared while drawing on the firm equals one stored, and that the way to make such signature matches what was done by the registered user. To this end, various parameters are measured when making a signature, such as writing speed, pressure or angle of the pen at each point in time when the signature is done, among other features. These signatures can be performed in a special screen that collects and analyzes all necessary signals for analysis or on paper if the pen with which the firm is able to measure the signals described above and send them to a server where you perform the analysis and the signature verification.

In patent MX2007007539 collects a system implementing the biometric authentication using an electronic signature. This system includes an interface to a computer capable of storing the movement of a cursor on a computer screen and compared with already stored signature patterns.

The first object of the present invention relates to performing a highly reliable authentication in a mobile device. Today, there are many applications that can be accessed from a mobile terminal where it is necessary to identify the user. For years entrusted all security on mobile devices to type a secret key that the user knew. However, these keys can be easily forgotten, transferred, lost or even counterfeit, so that user authentication is compromised.

According to this, the patent WO2008111012 comes to performing an authentication system for mobile devices that includes a biometric scanner to gather data and send them to a server that will perform the analysis and testing necessary patterns. The patent describes a mobile identification device associated with an identification and authentication system. The device can collect biometric data from a user and using a processor compare biometric data stored by the legitimate user and give access to a system if the comparison is successful. Using a wireless connection, the processor may transmit the identification information associated with another terminal, such as a mobile phone. For this it is necessary that the authentication server where the comparison is made to access a database that stores the biometric data such as the identification of each mobile device.

Focusing on the biometric technique to authenticate a user with a mobile device is found in US2006286969 and in US2008005575.

In US2006286969 it is proposed to have a remote authentication scheme to authenticate users from a mobile device. The biometric technique used is the voice recognition. The system consists of a mobile phone to send voice samples of an authentication device that connects to a database that stores the identities of mobile phones and voice pattern associated with that phone to make a comparison and check the user is talking on the phone is registered in the system.

US2008005575 proposes a method and apparatus for authenticating a user on a mobile phone. While the user holds the phone to his ear, a microphone emits a signal near the user's ear and the speaker phone is able to measure the ear's response to this signal. A processor analyzes the response signal and converts it into a signature that uniquely identifies each person and can be used to authenticate.

The object of the present invention proposes the creation of a human movement or gesture pattern with mobile device that identifies a user, taking into account that this gesture will only be known by the user and also that physical characteristics, it will perform differently to other people who might try to repeat the gesture.

Various techniques are known as gesture recognition, in which a system is able to detect when a user makes a certain known gesture. Some of these techniques known applications use gesture recognition to check if the nursing home patients are taking food from dinner. They use video signals dining and recognition techniques gestures of head and arms, analyzed using Hidden Markov Models (HMMs). Preferably studies are performed using HMMs to recognize hand gestures made corresponding Arabic numerals 0 through 9.

Also found US2009103780 and WO2009006173 patents related to methods to recognize standard gestures. Patent US2009103780 includes a method for collecting the gestures produced by hand, based on light hand at first by the palm and the back, to get your silhouette associated. From various lighting infrared proposes a method for collecting various hand movements and identifying a series of gestures previously stored in a database of gestures obtained in the same manner.

WO2009006173 patent describes a method for detecting response electronically gesture of a user is listening to a speaker using a mobile device. When performing a specific gesture, the speaker communicates an audible or visual display.

Related to the idea of recognition of a person by making a gesture found the patent WO2007134433. It develops a method to authenticate a user when performing an action that manual manipulation of a device such as a mouse. Authentication is to obtain the gesture with the mouse by the user when chasing a target and compare it to the stored pattern of the user when that objective has been pursued previously.

Focusing technical status to the present invention, it should be noted that performing gestures to biometrically authenticate a person on a mobile device using gestures measured with an accelerometer is novel.

Regarding the use of accelerometers in mobile devices there US2005226468 authentication systems proposed to authenticate the user based on certain biometric sensors must be connected to the mobile device, and verifies that the authentication was successful based on a accelerometer that collects data on how to get the user's device, ensuring it is not a machine trying to cheat the system.

Also, in US2009030350 discloses a method and a system for analyzing patterns gaits of a subject by measuring the acceleration of the head in the vertical direction while walking. It uses an accelerometer that is placed on the user's head. The analysis includes the creation of a signature from the acceleration data when user walk.

In the present invention also proposes the use of the patterns obtained by realizing the user gesture for generation or release of a cryptographic key. In this connection, patents found DE102005010698 and KR749380-B1.

DE102005010698 describes the construction of a cryptographic key for secure communication independent from the fingerprint. It proposes to use that key to communication demand TV with pay per view applications, child protection or age verification.

KR749380-B1 describes a method to generate a key from a biometric characteristic that does not change with time as the iris. The biometric information is received and preprocessed, extracted some values and associated cryptographic key is obtained by grouping the values. The clustering error is corrected using a block of Reed-Solomon code. The obtained key can be applied to any cryptographic system.

Consequently, it is desirable to have a highly reliable biometric recognition device, as described in the present invention, to avoid the drawbacks existing in the previous methods, apparatuses and systems as of the present state of the art. The present invention solution is intended to perform a biometric authentication which brings and combines together the two general characteristics of biometric authentication: the physical characteristics and behavior.

Therefore there is also a need in the art to have a mobile communication device that includes modules and methods for high reliability and easy to use way of authenticating a user of the mobile device, and locking or unlocking its communication functions and data storage capabilities in a case of negative or a positive authentication, that does not suffer from the disadvantages of traditional character based password protection systems and the disadvantages of systems and solutions such as in Shin's or O'Connor's.

Regarding to terminology used in this document portable communication equipment, also referred to herein as a “mobile radio terminal”, includes all equipment such as mobile phones, pagers, communicators, Notepads Notebooks and alike, e.g., electronic organizers, personal digital assistants (PDAs), smart phones or the like. It should also be appreciated that many of the elements discussed in this specification, whether referred to as a “system” a “module” a “circuit” or similar, may be implemented in hardware (circuits), or a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

### SUMMARY OF THE INVENTION

The following embodiments and aspects thereof are described and illustrated in conjunction with devices and methods, which are meant to be exemplary and illustrative, not limiting in scope. In various embodiments, one or more of the above-described limitations and emerging modern user's growing mobile devices daily secured use needs have been solved, reduced or eliminated, while other embodiments are directed to other advantageous or improvements.

The core of the present invention is an advanced and highly reliable new approach to protecting modern mobile devices against theft and in helping to allocate mobile devices in case of a loss. The invention device has an integrated highly reliable authentication module analyzing the user's hand pattern movement when uplifting the mobile device from its rest position.

A first aspect of the present invention comprises a mobile electronic device which enables a user to authenticate himself through the mobile electronic device and then enables a function of the mobile electronic device to differentiate between the authenticated legitimate user and a none authenticated none legitimate user by analyzing and detecting the user's personal unique and personalized movement sequence, while moving the mobile electronic device from its rest position.

The mobile electronic device comprises a 3D acceleration measurement module generating an acceleration signal representing the user hand motion in space while holding and uplifting the mobile electronic device. A lock/unlock circuit enables operation of at least one function of the mobile electronic device in response to the measured 3D acceleration signal indicating that the user holding the mobile devise hand motion pattern deviates from pre-recorded reference original owners hand motion uplifting movement signal data, while holding and uplifting the mobile devise by more than a predetermined threshold.

The lock/unlock circuit may further comprise an integration module and an executable authentication process module. The integration module integrates the acceleration signal with respect to time to generate a velocity signal and a displacement signal. The executable authentication process: i) compares a representation of the displacement signal and the velocity signal, with or without the acceleration measured signal, to the reference motion data. The reference motion data comprising reference displacement data and velocity data, with or without the acceleration measured signal data ; and ii) enables operation of at least one function of the mobile electronic device if the representation of the displacement signal and the velocity signal and the acceleration signal data deviate from the reference displacement data and velocity data and the measured acceleration data by more than a predetermined threshold. The reference motion data may also represents the devise legitimate users simple three dimensional gesture movements in space and the user motion represents the devise user moving the electronic device in the same simple three dimensional gesture.

The acceleration module may include at least two acceleration detectors and preferably three orthogonal linear acceleration detectors for detecting acceleration within a two dimensional plane or a three dimensional space. As such, the velocity signal and the displacement signal represent velocity and displacement of the mobile electronic device within the two dimensional plane or three dimensional space.

The process of comparing a representation of the displacement signal and the velocity signal to reference displacement data and velocity data may include: i) determining a sequential set of displacement coordinates values within the two dimensional plane or three dimensional space from the displacement signal, while the sequential set of displacement coordinate values representing sequential measured positions of the acceleration module within the two dimensional plane or three dimensional space at sequential time increments; ii) comparing the sequential set of displacement coordinates values to a reference set of coordinates values and determining that a gesture 3D movement and shape does not match, if the sequential set of displacement coordinate values deviates from the reference set of coordinate values by no more than a predetermined threshold; iii) determining a sequential set of velocity vector values within the two dimensional plane or three dimensional space from the velocity signal, the sequential set of velocity vector values representing a speed component and a direction component at each of the sequential set of displacement coordinates; iv) comparing the sequential set of velocity vector values to reference velocity vector values and determining that a velocity model matches if the sequential set of velocity vector values deviates from the reference velocity vector values by no more than a predetermined threshold; and iv) generating the indication of user authentication only if the movement shape and the velocity model match within a predefined coordinates values difference.

A second aspect of the present invention is to provide a method of enabling a theft and/or loss protection function of a mobile electronic device. The method comprises: i) prompting a user to move the mobile device from a rest position using the housing of the mobile electronic device; ii) detecting acceleration of the housing of the mobile electronic device within at least two dimensions (e.g. within a two dimensional plane or a three dimensional space) and iii) generating an acceleration signal representing the user hand gesture while uplifting the mobile devise; and iv) enabling lock or unlock of at least one function of the mobile electronic device in response to the acceleration signal indicating that the present user devise uplifting hand motion deviates from reference motion data by more than a predetermined threshold.

Enabling operation of a function of the mobile electronic device may comprise: i) integrating the acceleration signals with respect to time to generate a velocity signal and a displacement signal; ii) comparing a representation of the displacement signal and the velocity signal to the reference motion data, the reference motion data comprising reference displacement data and velocity data; and iii) enabling operation of at least one function of the mobile electronic device if the representation of the displacement signal and the velocity signal deviate from the reference displacement data and velocity data by more than a predetermined threshold. The reference motion data may represents a user's typical movement pattern and the user motion represents the user moving the mobile electronic device in a typical movement from the devise rest position motion.

The method may further comprise driving an integration module to integrate the acceleration signal with respect to time to generate a velocity signal and a displacement signal. The representation of the acceleration signal may comprises a representation of the velocity signal and the displacement signal,

According to the present invention, there is also provided highly secured against theft and loss mobile electronic device comprising: a. a three dimensional acceleration sensor module generating a XYZ coordinates based acceleration measured signal representing a user's 3D hand motion sampled data sequence in space while lifting from a stationary position and holding said mobile electronic device;

b. an electronic software activated lock/unlock circuit for enabling operation of one or more alarm and emergency functions and for inhibiting voice communication functions of said mobile electronic device in response to said measured acceleration time based 3D signal sequence; and c. wherein said lock/unlock activated alarm triggered set of functions activation and operation is indicating that said user samples data sequence of 3D motion while lifting and holding said device, when compared to a similar reference prerecorded and stored set of sampled data of a three dimensional user's hand motion pattern in space made by said devise legitimate user, while lifting said device from a stationary position, deviates from each other by more than a predetermined threshold.

According to the present invention, there is also provided another embodiment of highly secured against theft and loss mobile electronic device further comprising; d. an additional tilt sensor module generating a three dimensional tilt angles sampled signal vector representing said devise up-lifting and said user's holding hand 3D angular motion in space; and e. wherein said three dimensional XYZ coordinated acceleration signal vector results are fused together using a continuously learning and changing weighted factor fusion algorithm, for optimal fusing together with said measured three dimensional tilt angles sampled signal vector results, to enable improved and more precise analysis and identification of the exact typical personal characteristic movement of said user holding said electronic devise, thus creating a highly reliable user's authentication mechanism to decide while comparing to a similar reference prerecorded fused set of said two kinds of sampled user's hand motion characterizing data, if to activate said lock/unlock circuit for enabling operation of said one or more emergency functions of the mobile electronic device.

According to the present invention, there is also provided another preferred embodiment of a highly secured against theft and loss mobile electronic device wherein the lock/unlock circuit further comprises an integration module for integrating said measured acceleration signal with respect to time to generate a velocity signal and a displacement signal; and an executable authentication process for comparing a representation of the 3D displacement signal and the 3D velocity signal to the reference pre-recorded motion data, said reference motion data comprising reference 3D displacement data and reference 3D velocity data in addition to said acceleration reference data and enabling operation of the comparison and analysis based user's authentication function of the mobile electronic device if the representation of the displacement signal and the velocity signal and the acceleration signal data deviate from the reference displacement set of pre-recorded data and velocity set of prerecorded data and acceleration signal set of prerecorded data by more than a predetermined threshold.

According to the present invention, there is also provided another preferred embodiment of a highly secured against theft and loss mobile electronic device, wherein the lock/unlock circuit further comprises a data processing module for creating the derivative of the 3D tilt signals with respect to time to generate an angular velocity signal and a an angular acceleration signal of said mobile devise; and further executing an authentication process for comparing under a continuously learning weighted factors fusion algorithm the combined weighted representation of the 3D displacement signal, the 3D velocity signal, said 3D acceleration data, said 3D angular data, together with the 3D angular speed signal and the 3D angular acceleration data and to compare it to the reference pre-recorded motion data, the reference motion data comprising reference 3D displacement data, a reference 3D velocity data said 3D acceleration data, together with said reference 3D angular data, a reference 3D angular speed data and a 3D angular acceleration data; and g. then further enabling operation of the lock/unlock function of the mobile electronic device if the representation of the 3D displacement signal, the 3D velocity signal, fused with the 3D angular speed signal and the 3D angular acceleration signal deviate from said reference motion data by more than a predetermined threshold.

According to the present invention, there is also provided another preferred embodiment of a highly secured against theft and loss mobile electronic device, wherein said reference motion data represents the device user's normal sampled and continuously averaged pre-recorded 3D up-lift movement pattern of said mobile devise from its stationary position on a resting surface or from a continuous and repetitive movement pattern when the electronic mobile devise is carried on a user's body, or when it is uplifted from a carrying bag and the user motion represent the user momentary uplifting 3D movement pattern of said electronic device from its present resting surface, or from its present dynamic position continuous and repetitive movement pattern, when said device is carried on a user's body, or when it is uplifted from a carrying bag.

According to the present invention, there is also provided another preferred embodiment of a highly secured against theft and loss mobile electronic device, wherein the mobile device: further comprising: a. a dedicated secured soft key switch for user's activation/deactivation control of said mobile electronic device electronic software which in case of a false user's authentication activates a lock/unlock alarm circuit enabling said operation of one or more emergency functions of the mobile electronic device; b. user intervention free self-triggered activation of the lock/unlock function ready for use is enabled only after an N user defined minutes of said mobile device being in a stationary position status or after an M user defined minutes said devise is carried in a continuous steady movement sequence of said mobile device; c. a display unit for indicating status of the mobile electronic device and display of data; and wherein the a movement activated emergency alarm function of said mobile electronic device enabled by said lock/unlock circuit comprises at least one function selected from a group of functions consisting of at least: i) setting up a highly audible audio alarm through said electronic device having integrated audio signals generation capabilities; and ii) generating a display function of said display unit indicating and alarming by flashing and fixed combination of text, graphics and icons the lifting and moving event of said device by an illegal non registered user.

According to the present invention, there is also provided another preferred embodiment of a highly secured against theft and loss mobile electronic device, wherein the lock circuit comprises: an integration module for integrating the acceleration signal with respect to time to generate a velocity signal and a displacement signal; and an executable authentication process for: comparing a representation of at least one of said uplifted mobile device measured signals group, including the displacement signal, the velocity signal and the acceleration signal to the reference motion data, the reference motion data stored on said uplifted mobile devise memory comprising at least one of the group of reference movement data including the displacement signal, the velocity signal and the acceleration signal motion data; and enabling operation of the function of the mobile electronic device if the representation the measured signals group deviates from the reference stored signal group by no more than a predetermined threshold.

According to the present invention, there is also provided another preferred embodiment of a highly secured against theft and loss mobile electronic device, wherein the mobile device is further comprising: a. a wireless transmission system for the exchange of wireless data signals between said devise and a remote system; b. a software operated self triggered switch for a suspected theft event generated control signal of said mobile electronic device preparing and sending said device user data and said device momentary location to said remote system; c. a display unit for indicating status of the mobile electronic device and display of data received from said remote system; and d. wherein the function of said mobile electronic device enabled by the activation of said lock/unlock circuit comprises at least an alarm, said mobile devise momentary geographical location and emergency generation data transmitted through a wireless data

According to the present invention, there is also provided another preferred embodiment of a highly secured against theft and loss mobile electronic device, wherein, further comprising; e. a software module containing a registered list of said devise user close group of persons and their direct access communication data; and f. said software module sending said group of persons alert messages including said mobile devise momentary location, in case of an emergency case, such as when said devise senses that a suspected theft event has occurred.

According to the present invention, there is also provided another preferred embodiment of a highly secured against theft and loss mobile electronic device, wherein, further comprising a software module operating automatically said device integrated camera module and its lighting flash modules facing up when said devise is lifted from its resting position by a non-authenticated user and sending said non authenticated user pictures in a serial sequence continuously to said remote system and to said list of phones of said close persons. Sending said close friends alert messages including said suspected theft devise momentary location, its theft alert message and said devise continuous sequence of pictures, in case of an emergency case like said devise theft has occurred.

According to the present invention, there is also provided another preferred embodiment of a highly secured against theft and loss mobile electronic device, wherein the reference motion data that represents the device legitimate user upon said device initial enlisting process includes said device recorded uplifting 3D sampled motion pattern and the user motion represents the present user moving the electronic device in an uplifting typical motion.

According to the present invention, there is also provided another preferred embodiment of a highly secured against theft and loss mobile electronic device, wherein the mobile devise is operating as a user's authentication client to a remote service provider system, said mobile electronic device further comprising: a. a wireless transmission system exchanging wireless data signals with said remote service provider system; b. an acceleration module generating an acceleration signal representing user motion of the mobile electronic device; and c. an authentication system comprising: an executable authentication process for receiving a authentication call generated by the remote service provider system and transmitted to the mobile electronic device via wireless signal; and returning a representation of the acceleration signal to the remote service provider system.

According to the present invention, there is also provided another preferred embodiment of a highly secured against theft and loss mobile electronic device, wherein the mobile devise is further comprising an integration module for integrating the acceleration signal with respect to time to generate said mobile device velocity signal and an associated displacement signal; and the representation of the acceleration signal comprises a representation of the velocity signal and the displacement signal.

According to the present invention, there is also provided another preferred embodiment of a highly secured against theft and loss mobile electronic device, wherein the devise is further comprising a second dedicated secured soft key switch for user's deactivation control of said mobile electronic device electronic already activated lock/unlock alarm circuit enabling one or more emergency functions of said mobile electronic device, wherein activating said second soft key enables the user to select one of the following alarm deactivation functions: i. said user is requested to feed in his pre-registered user name and password into displayed blank spaces appearing in said device screen once said second soft key is activated by said user; and ii. a voice data processing module is activated by said second soft key activation on said mobile device, wherein at that stage a human voice activated question is played to the user and then waiting to be vocally shortly responded by said legitimate user voice, wherein said activated voice question is randomly selected from a set on N user's personal data questions stored in said mobile device memory together with the associated expected user

According to the present invention, there is also provided another preferred embodiment of a highly secured against theft and loss mobile electronic device, wherein, further comprising; d. a Bluetooth transceiver data communication module integrated in said mobile electronic devise; e. a second RF radiation level sensitive Bluetooth mobile transceiver pocket size sensor device, incased in a compact package and normally connected to said user set of private access and door locks key holder; and f. wherein said second device is activating said lock/unlock alarm triggered set of functions in said first mobile devise, whenever the communication distance between said first and said second devise is larger than a pre-defined distance of m meters while the associated detected RF communication signal between said first and second devise if lower than a predefined threshold.

According to the present invention, there is also provided another preferred embodiment of a highly secured against theft and loss mobile electronic device, wherein the second RF radiation level sensitive sensor device is a passive RFID sensor back reflecting modulated energy coming from said first mobile devise RF transmitter and reflected back to said first mobile devise RF receiver.

According to the present invention, there is also provided another preferred embodiment of a highly secured against theft and loss mobile electronic device, wherein the mobile devise further comprising a tilt triggered sensitive module, wherein said electronic software activated lock/unlock circuit for enabling operation of one or more alarm and emergency functions is operating an audio location indication sound in said mobile devise whenever said mobile devise in a hand carried bag or briefcase being shaken by said user in purpose along the XY plane without a significant uplifting lifting movement along the Z axis to enable indication that said mobile devise is in sad hand bag without the need to open and check said bag content.

According to the present invention, there is also provided another preferred embodiment of a highly secured against theft and loss mobile electronic device, wherein the mobile devisees further comprising an anti-theft reference marker visible on an external portion of the housing of said mobile electronic device, said reference marker indicating and warning potential thieves that said mobile electronic device has a built in anti-theft module and including a phone number to call by the finder, in case of said mobile devise loss.

According to the present invention, there is provided a preferred embodiment of a highly secured method of using a protected against theft and loss mobile electronic device according to the present invention, wherein the invention preferred embodiment method is enabling a theft deterrent or a loss case protection function for a mobile electronic device, the method comprising: a. prompting a user to register his phone in an anti-theft and loss avoidance application while said user uplifting his mobile device and holding the housing of said mobile electronic device and recording said lifting movement pattern characteristics; b. detecting acceleration pattern of said mobile electronic device within three dimensions and generating and recording in said devise an acceleration signal samples data representing the user hand movements uplifting his mobile device from a platform; c. enabling operation of a theft warn or a misuse alarm functions of said mobile electronic device in response to the measured acceleration signal indicating that the present user motion deviates from said recorded reference motion data stored on said mobile device by more than a predetermined threshold, wherein enabling further operation of a function of the mobile electronic device comprises: d. integrating said acceleration signal with respect to time to generate a velocity signal and a displacement signal; comparing a representation of the displacement signal and the velocity signal to the reference motion data stored in the memory of said mobile device, the reference motion data also comprising reference integrated displacement data and velocity data; and e. enabling operation of said theft deterrent or a loss case protection function of said mobile electronic device if the representation of the displacement signal and the velocity signal deviates from said reference displacement data and velocity data by no more than a predetermined threshold.

According to the present invention, there is provided another preferred embodiment of a highly secured method of using a protected against theft and loss mobile electronic device according to the present invention, wherein the reference motion data represents a pre-recorded mobile device owner sampled hand motional data while said devise owner uplifting his device with a simple normal or a simple 3D user created hand movement pattern and the user motion represents a user uplifting said electronic device in a tracked and sampled motion.

According to the present invention, there is provided another preferred embodiment of a highly secured method of using a protected against theft and loss mobile electronic device, operating the portable electronic device as a user authentication platform for anti-theft protection while communicating with a remote service provider system, comprising: a. transmitting via wireless signal, an authentication call registration request generated by said electronic device legitimate owner operating a 3D acceleration measurement based module to generate a measured and further calculated acceleration, speed and displacement signal based sampled data set representing said owner uplifting natural or self-created uplifting motion of the mobile electronic device; b. sending via wireless signal transmission to said remote service provider system, a false authentication alarm signal created by the representation of the comparison at least two out of the measured device uplifting acceleration, speed and displacement set of signals while comparing it to at least two of a pre-recorded uplifting set of sampled data containing the acceleration, speed and displacement reference sampled signal data made by said device legitimate owner, which is stored in said device; and c. when said service provider receives said wireless message containing said false authentication alarm signal from said electronic device it sends theft alarm notification via short message signal (SMS) to a prerecorded set of phone numbers stored at said service provider memory containing a preferred relatives and friend list of said device legitimate owner.

According to the present invention, there is provided another preferred embodiment of a highly secured method of using a protected against theft and loss of a mobile electronic device according to the present invention, further comprising: driving an integration module in the mobile devise to integrate the measured acceleration signal with respect to time to generate a velocity signal and a displacement signal; and then said representation of the acceleration signal comprises a representation of the velocity signal and the displacement signal.

According to the present invention, there is provided another preferred embodiment of a highly secured method of using a protected against theft and loss of a mobile electronic device, further comprising: d. upon a user's false authentication event, automatically initiating and processing upon the non-authenticated user a set photography and face recognition functions through said mobile devise integrated electronic camera module and integrated processor and sending the processed non authenticated user photography processed data to a central remote service provider system for recoding and further theft related data management requirements; and e. avoiding sending such alarm to said remote service provider system if said face recognition function results indicate a high match to a stored face authentication data out of said device legitimate owner and of additional close family authenticating faces data bank, prerecorded and stored on said devise.

Unless otherwise defined, all technical and/or scientific terms used herein have the same meaning as commonly understood by one of ordinary skill in the art to which the invention pertains. Although methods and systems similar or equivalent to those described herein can be used in the practice or testing of embodiments of the invention, exemplary methods and/or systems are described below. In case of conflict, the patent specification, including definitions, will control. In addition, the materials, methods, systems and examples herein are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is an illustration of a schematic block diagram of one possible aspect of the mobile electronic device configuration according to the present invention that includes a microprocessor module, a display module, an authentication module, an acceleration detectors module, a tilt detectors module, an audio module, a camera and image processing module, an RF communication module and a plurality of storage modules.

FIG. 2 is a schematic illustration of a state machine in the form of a flowchart, wherein the flowchart is representing the initials stages of the devise application mode preparation and its sensors activation events, prior to the initiation of the authentication process, possibly followed by the activation of an alarm by the present invention mobile devise, according to one possible embodiment of the present invention,

FIG. 3 is a schematic illustration of a state machine in the form of a flowchart, wherein the flowchart is representing the post rest stages of the devise re-movement sensing followed by the devise user's authentication execution, to be then followed in case of an illegitimate user, by the activation of an alarm by the present invention mobile devise, according to one possible embodiment of the present invention,

FIG. 4 is a schematic illustration of a state machine in the form of a flowchart, wherein the flowchart is representing the execution events in the t devise user's negative authentication alarm activated mode of the present invention mobile devise, executable during the devise uplifting triggered movement analysis process, according to yet another embodiment of the present invention, wherein two types of movement sensors output measured data sources are fused together under a learning algorithm to create higher reliability and precision of the devise and the holding user's hand 3D movement pattern in space to be further analyzed by the devise in the following user authentication process.

FIG. 5. is a schematic illustration of a state machine in the form of a flowchart wherein the flowchart is representing the execution of events in the present devise user non authentication alarm activated mode of the present invention mobile devise, to be triggered under an uplifting triggering process, according to yet another embodiment of the present invention, wherein one type of a 3D movement sensing sensors module output measured data is fused together under an authentication algorithm with the measured and calculated data output of the devise present user face recognition software module, required to create higher reliability and quality of the present user authentication process.

FIG. 6. is a schematic illustration of one possible embodiment of the present invention mobile devices security management system, combining also demonstrating the protected device several operational security status checks and authentication stages and states in the form of a flowchart, wherein the flowchart part is representing the execution of events in the case of the devise user non authentication alarm followed by the immediate communication that the alarm event creates with the remote security monitoring center, which in this embodiment is supported by the device cellular service provider communication system.

### DETAILED DESCRIPTION OF THE INVENTION

The present invention, in some embodiments thereof, relates to mobile devices antitheft and loss security related solutions and, more particularly, but not exclusively, to methods, a device and a system to manage and conduct mobile devices bio authentication and execution of various alarms and notifications in case of a non-legitimate user authentication failure.

Before explaining some embodiments of the invention in details, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a devise, a system, a method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access solid state memory (RAM), a read-only memory (ROM), an erasable programmable read-only memory (EPROM or Flash Memory), an optical fiber, an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to electronic, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's smartphone, partly on the user's smartphone, as a stand-alone software package, partly on the user's smartphone and partly on a remote computer, or entirely on the remote computer or server. In the latter scenario, the remote computer may be connected to the user's mobile device through any type of network, or the connection may be made to an external computer (for example, through the Internet using an Internet Service Provider, or through a cellular service provider).

Aspects of the present invention are described below with reference to flowchart illustrations and/or block diagrams of devices, methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a smartphone, a notepad, a laptop, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a smartphone a mobile or portable computerized device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

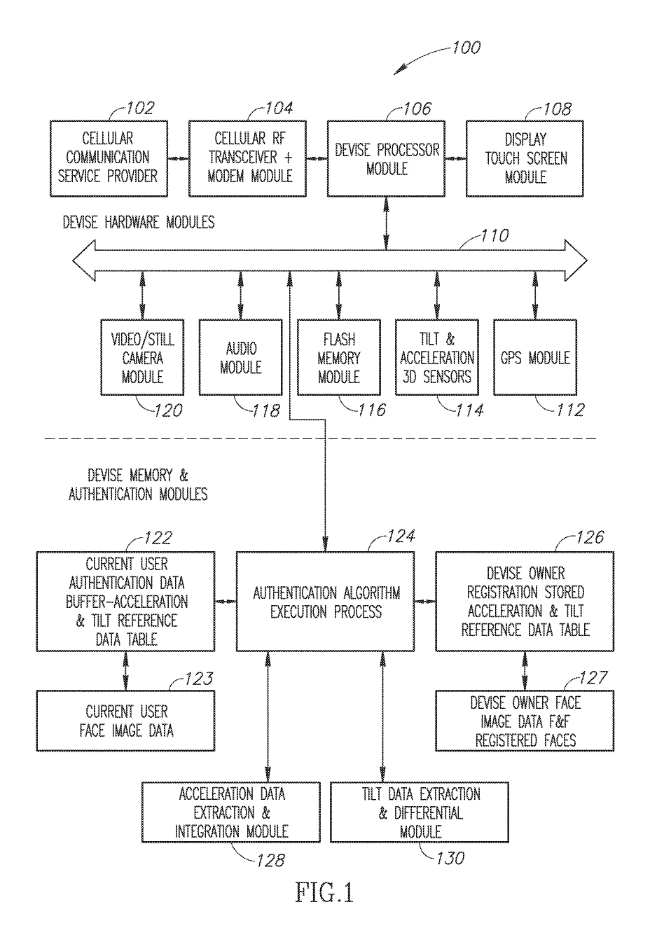

Reference is now made to FIG. 1, which is an illustration of an example of a computerized mobile device hardware and software content and configuration according to the present invention. 100 is representation of an exemplary present art mobile device with a built-in user's bio authentication capabilities based on gesture analysis of the user hand movements while picking up or handling the mobile devise. The present invention mobile devise 100 is communicating with a cellular communication service provider 102 through the cellular wireless networks as required to operate some of the dedicated functions related to the present invention mobile devices local and remote security management functions. Cellular RF transceiver and Modem module 104 is representing the mobile device module that supports and enables the device data and voice communication with the cellular service provider 102 and with other cellular subscribers, the mobile device processor 106 is controlling all the device various functions of management and processing, plus the sampling and the processing of the device movement sensors data, as required to support the execution of user's authentication program 124, based on his gestures and movements sampled data. The display module 108 is a combination of a graphic/image display screen and a touch sensitive screen to support the user's various interaction and the display of the interactions results with the mobile device 100. The device central internal data communication bus 110 supports the needs to transfer data and commands between the various modules of the mobile device 100. Module 120 is the mobile device internal or external still and video image generator, including one or more electronic camera units that support the triggering and imaging of the devise user face in order to document and authenticate the user according to his face details according to some embodiments of the present invention. Audio module 118 is including at least one microphone and at least one speaker that enable the voice communication of the user with other users and for the potential support of the user's authentication, based on his voice personal characteristics analysis. Flash memory module 116 is at least one solid-state memory modules resident within the mobile device 100 that holds the operational software of the mobile device as well as the functional software modules 122,124 and 126 that supports the invention mobile device 100 to function as an anti-theft protected security sensor and a multiple types of alarms initiator. Tilt and acceleration 3D sensors module 114 is a unit resident within the invention device 100 that measures the linear acceleration on the three orthogonal axis of the device and the 3D tilt angles of the device in space. GPS module 112 is another important built in sensor within the present invention anti-theft protected mobile device, wherein the GPS world coordinated device dynamic poison reading so to enable the allocation of the device in case of a theft or other security problematic cases.

Module 122 is a flash memory buffer containing the device sampled movement data of the current security evaluated user including his measured gesture 3D measured acceleration changes pattern and the device 3D tilt changes sampled data, while being held by the current security evaluated user. The data buffer module 122 is also connected with sub-module 123 that samples and stores the current user face images digitized data, to further use it as the user's additional channel of bio authentication sources, according to at least one of the present invention authentication embodiments. Module 124 is the central SW module in the present invention device managing the selection of optimal process for choosing and executing the optimal residing authentication algorithm, choosing one of several authentication algorithms and significant user identification sources options. The 124 module does the analysis the user's gesture, based on the measured output of one or more movement sensors measuring the 3D device movement in space. The 124 module also creates the improved quality and reliability authentication process while fusing together the user's measured gestures pattern data measured by the invention mobile device using more than one movement type sensors output, while in parallel in another embodiment of the present invention authentication method, wherein the method is implementing into the authentication process the user's face pattern recognition data, as the second source of the user's bio personal data, thus enabling an optimal quality authentication process, combining gesture and face personal bio data.

Module 124 has another set of functions for execution in the cases that the authentication process of the current device holder is indicating a non-authenticated user case. In such a case the module 124 is creating a series of preprogrammed alarm functions, creating audio alarm set of signals on the audio module 118 and displaying visual eye attracting flashing images through the display module 108. In parallel alarm data is sent from the invention mobile device to a remote cellular service provider and through it to a set of the users who are the device owner group of pre-selected piers to notify them on the event of theft and the location of the theft as it is constantly read and transmitted by the GPS module 112. Software module 126 is storing and managing legitimate user reference registration data, as required by present invention theft protected mobile device 100 while managing the registration movement pattern of the legitimate user prepared and stored by module 126 to serve as the reference set of data while compared to the current user measured gestures movement data. A sub module connected, functioning with and used by module 126, is 127 that stores and manages the legitimate device owner face data including its face recognition parameters and also stores and manages the registered user's piers (friends and family) face recognition data to avoid false operation of the device alarm functions when one of the legitimate user's piers is by mistake lifting and holding the invention theft protected mobile device. Module 128 is a SW module that manages the extraction of the sampled acceleration measurement 3D set of sensors and also in processing integration algorithms on the acceleration measured device results data in order to achieve data related to the device velocity and position in space, based on the acceleration data one time and two times integration calculation results, Module 130 is a SW module that manages the extraction of the sampled tilt measurement 3D set of sensors and also in processing derivatives algorithms on the tilt angles measured device data results, in order to achieve data related to the device angular velocity and angular acceleration in space, based on the measured 3D tilt angles data, one time and two times derivatives calculation results,

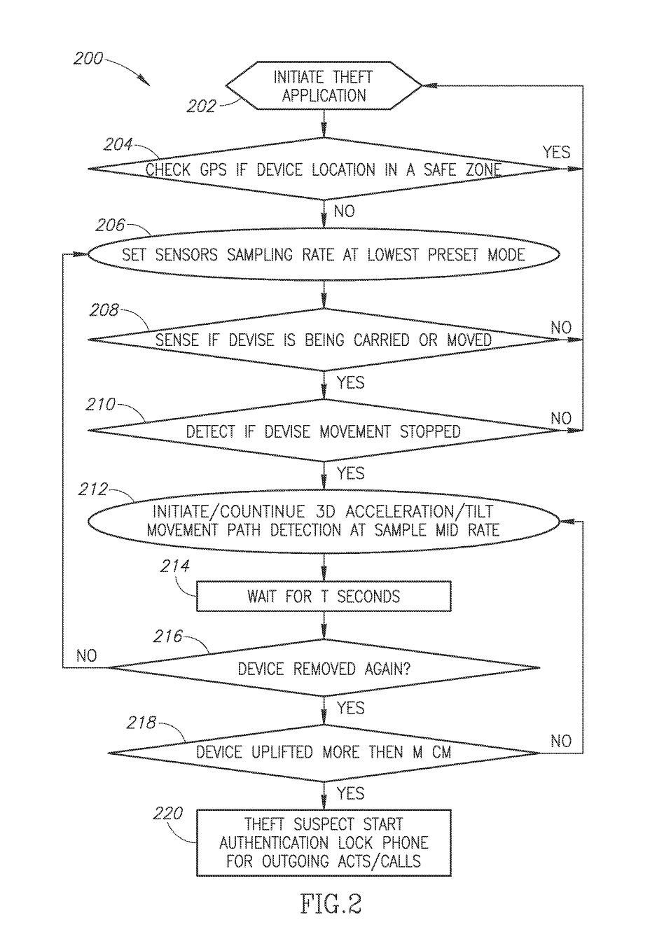

Reference is now made to FIG. 2, which is a schematic illustration of a state machine wherein states reflect actions and transition arrows relate to external triggers which are performed with regard to a certain layout, according to one embodiment of the present invention, wherein this state machine is demonstrating the different change states of the present invention theft secured mobile device 100, and wherein the flowchart 200 is representing the initials phase of the devise anti-theft application preparation stages and its sensors activation events, prior to the initiation of the suspected public place user authentication process, possibly followed by the activation of an alarm by the present invention mobile devise, according to one possible embodiment of the present invention. Stage 202 is representing the initiation by the user of the anti-theft device protection mode by activating a button or a voice command, otherwise the mobile devise is not theft protected. Stage 204 is representing a question state of two alternatives selection, requiring the device to initiate an internal device GPS reading command in order to get the device embedded GPS sensor module generate an updated position of the present invention mobile device. Alternatively if the GPS generates no reading, the device is then automatically transferring to communicate through the cellular connection, or thought the embedded Wi-Fi transceiver module, with the Google Location Based Services center (Google maps API) providing an internet based location services solution, which is defining the mobile device location data, based on most nearby Wi-Fi_33 hot-points location triangulations, effective and provided by Google even in low GPS reception areas like indoors. The user has to predefine upon his first time registration to activate the anti-theft mode in the device, what are the coordinates of locations of safe zones for his mobile phone, where there is no risk for the device theft case. Such a safe zone can be the device owner home, work place, close relatives' or friends home places, etc. in Stage 204 the devise program is checking if it is in a safe zone and if yes then going back to the standby initial antitheft mode option. If the device location checking stage 204 shows that the devise is out of any safe zone, then it moves to stage 206 defining the sensors reading rate at the antitheft operational initiation mode, where it samples in a low sampling rate of about one sample reading/sec or less of the position sensors output, while choosing for that movement sensing either the acceleration sensors output sampling or the tilt sensors sampling, or both. Stage 208 is a selection state, where the system is doing an analysis of the device measured tilt and acceleration dynamic reading output statuses and decides, based on the measured output, if the mobile device is stationary, or in a continuous movement mode when carried by its user from point 1 to point 2 during the user's normal daily activities. If there is no change in the sensors reading it means that the device is out of the protected zone but is not in a use state and then the process goes back to initial anti-theft protection active standby mode symbolized by stage 202. Alternatively if the devise is being moved the state machine is shifting to stage 210 when it starts checking if there was a devise movement event that was is stopped for more than M amount of pre-defined minutes, means that the user has arrived to a new stationary activity base location, which is not within a safe zone. This can be a café, a restaurant, a shop, or any public, work or social meeting zone where the devise user is spending some time and when the device is at rest at that time and might be then stolen or lost. In such a case the device shifts to an alert standby mode stage 212, where the devise raises the movement sensors output sampled reading rate to an alert stage higher rate in the typical range of 5-10 reading samples/sec, in order to get better reaction time and movement alert sensitivity to any potential threat, typical to the start of a real theft event. After shifting to stage 212 and the related execution of the processor shifting the device to a higher movement sensor sampling rate with a better movement detection sensing capability, the device then changes state to stage 214 and waits for another period of T1 minutes in the typical range of 3-10 min when the sensors are giving the device the indication that the device is in a horizontal orientation and not moving and then the device checks in stage 216 again if the device has been moved again following this waiting no movement period, if yes, the suspect of a possible theft event is getting higher and the device is moving to high theft suspect stage 218. If the devise was not moved again within the predefined horizontal position state T1 minutes period, when the device has a high potential exposure to theft while resting on a table, part of the time maybe being unattended by its user in a public place, the device theft suspect level is then reduced and the devices status shifts back to stage 206, which is the normal standby stage typical to safeguard a device that is out of a safe zone and being carried by its owner. If the device was moved again in stage 216 then the device theft protection stage sequence moves to stage 218 where the device is checking that the device was uplifted from it no movement horizontal opposition to a minimum additional M cm distance above it horizontal rest position and along the device Z vertical axis, or alternatively to measure the time duration of the uplifting movement when the movement was up and for at least T2 time duration defined by the number of seconds which is equivalent to the time duration needed to move up the device by at least M cm with a normal hand uplifting speed, as it is needed to start the authentication only in the case that the present user is raising the device above its horizontal stage at state 214 by at least typically 10 cm up, or any distance near to it, to avoid false alarm event when the user is just moving the device on the table or tilting it to watch incoming messages or read the present time. If the condition made in stage 218 is achieved then the device shifts to stage 220 where an authentication process starts upon the present user that has lifted the device up. If the condition of stage 218 is not fulfilled then the state machine turns the device to stage 212 waiting again for T1 minutes to start the process again.

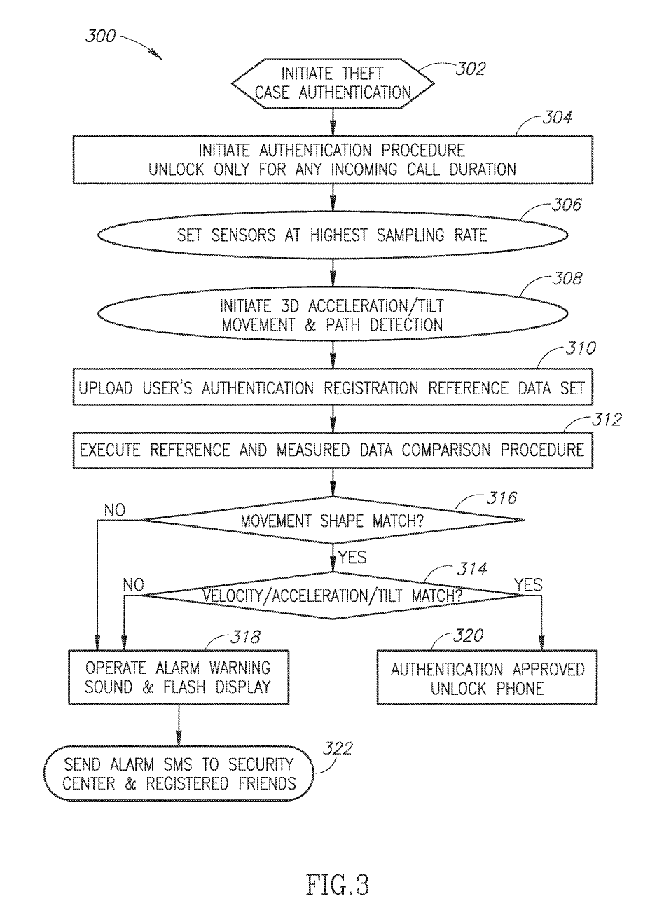

Reference is now made to FIG. 3, which is a schematic illustration of a state machine wherein states reflect actions and transition arrows relate to external triggers which are performed with regard to a certain layout, according to one embodiment of the present invention, wherein this state machine is demonstrating the different change states of the present invention theft secured mobile device 100, and wherein the flowchart 300 is representing the user's authentication and possible alarm activation phase of the devise anti-theft management SW stages and its relevant movement measuring sensors optimal activation events, according to one possible embodiment of the present invention. Stage 302 is representing the start of the authentication process of the present user who is uplifting and holding the devise. Stage 304 is representing a state that is requiring the device to enter into the authentication process and in parallel to block the device from making and executing any outside calls or data communication such as emails/SMS and internet data exchange and enable only the receipt of incoming calls until finalizing the authentication process, then either clearing and accepting the current user as the legitimate owner and reopening the phone for all types of its functions, or shutting it down completely except transmitting alarm related messages. In Stage 306 the devise program controls the related execution of the processor shifting the device to the highest possible movement sensors sampling rate of typically, but not exclusively to 20 samples/sec, thus enabling an optimized movement pattern detection and sensing capability, and using the required higher battery power consumption only for the short time duration that is required to execute the current user several authentication process stages. In stage 310 the devise program is uploading from the devise memory the stored user's enrollment measured devise owner recorded uplifting samples gesture measured movement pattern data, a file that has been done and stored in the device memory in the initial registration phase of the device owner, as required to initiate the antitheft protection entire procedure in the mobile device. Following to uploading from the device memory the device stored owner's recorded registration gesture reference sampled data done in stage 310, then in the following stage 312 the device is executing the comparison of the stored owner's uplifting gesture data to the sampled present user uplifting measured sensor's movement samples of the device uplifting gesture data. If the measured shape of the present user device movement pattern in space is matching the software based reconstructed device movement pattern shape in space of the device owner's original registration data and they match each other above a pre-defined threshold level. Then the devise program moves to stage 316 for another higher level comparison and matching test phase. In stage 316 the device is executing at least one out of three measured movement parameters comparisons to the stored device owner registration related data. The stage 316 comparison activities is comparing the uplifted device sampled 3D movement data sequence in the authentication session, using one or more of the devise acceleration, velocity and tilt angles parameters and their associated sampled data sequence change in time during the measured gesture time—to the identical set of data samples done by the legitimate device owner and recorded on the device during the initial user's registration phase. If the matching score is high above a predefined threshold level then the device state machine is moving to stage 320 where the devise has fully authenticated the present user and identifies him as the device original and legitimate registered user and then it opens all the device voice and data communication channels for free 2-way communication by the present user holding the device until the device is later going back to stage 202 or to stage 302, depending on the further use of the device after the authentication is confirmed and device is free to be fully used by its present user. When the comparison results of stage 316 show negative match results between the reference device 3D movement shape data and the present user device holding hand movement shape data, then the state machine moves to stage 318 which is the alarm activation stage when the devise is activating a preprogrammed high level sound alarm selected by the user and in parallel a visual alarm displayed session is running on the device screen with pulsating lights and various user pre-use selectable flashing screen size visual alarm graphic and textual notes. When the comparison results of stage 316 show positive high level match results between the reference 3D device movement data and the present user device 3D movement data, then the state machine moves to stage 314 which is the state where the device SW and its CPU processor are comparing the measured results of the movement velocity and/or acceleration and/or tilt match between the present user hand movements and the registered set of user' original enrollment process movement velocity and/or acceleration and/or tilt, if the results show no match the state machine moves to stage 318 and activates alarm as well. If comparison done on stage 314 show good match above a predefined SW driven matching threshold, then the device CPU move the state machine to stage 320 where it decides that the present user is the legitimate owner of the device and the phone is unlocked to enable it full functions operation the device. In stage 318 the device operates the alarm activation stage when the device creates a high level sound alarm, that might be selected by the user from a pre-recorded alarm sounds library and in parallel a visual alarm displayed session is running on the device screen with pulsating lights and various user pre-use selectable flashing screen size visual alarm graphic and textual notes. Further to stage 318 when the device has activated the alarm, the device operational state machine is moving to stage 320 where a SMS alarm notification is generated by the device and sent through the cellular networks to a list of cellular numbers of registered piers and relatives of the device user notifying them on the devise theft and sending to them the present GPS measured device position coordinated, or Google location based services of Wi-Fi hot-points triangulation based reading, covering the detected present location of the device and an image of the device present carrier/user, that is made automatically in a sequence of still images made by the device embedded camera where stage 318 is activated.

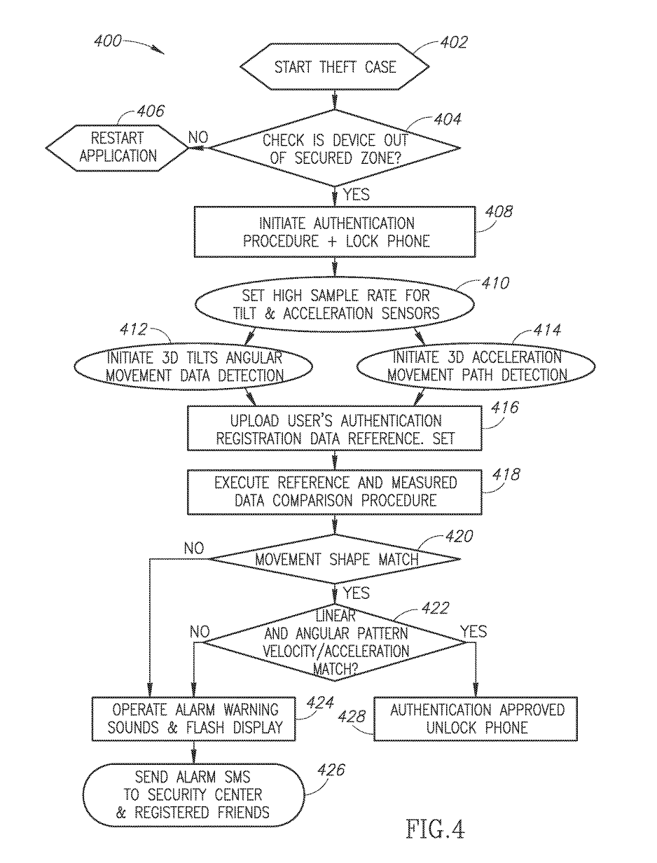

Reference is now made to FIG. 4, is a schematic illustration of a state machine wherein states reflect actions and transition arrows relate to external triggers which are performed with regard to a certain layout, according to one embodiment of the present invention, wherein this state machine is demonstrating the different change states of the present invention theft secured mobile device 100, and wherein the flowchart 400 is representing the user's authentication and possible alarm activation phase of the devise when the authentication process is initiated where the device is not situated in what was predefined by its user as a secured zone where no alarm activation is required in any event. Stage 402 is the starting point in the activation of the state machine of the SW activating the device according to its momentary position. In stage 404 the device is checking its position coordinates to analyze and define if its location is in a safe zone or not, this safe location state is related to being in protected and trusted pre-defined user's and his device location zone, like home, family, or work place. If location is found to be in a safe zone it moves to stage 406 were the device is safe and waits for change in location or activation of authentication by the user. If the location assessment in 404 finds the device to be in a non-secured zone it moves to stage 408 where automatically it starts requesting the user/holder to do an authentication hand movement based action and in parallel it is locking and blocking the mobile device communication and other operational capabilities by the automatically firing of the procedure described in FIG. 4 related state machine steps and the related device SW configuration In case the device location is not a user's defined safe zone.

Moving to stage 410 is automatically initiated following starting the authentication phase in stage 408. To enable higher accuracy measurement of the device accelerometers and gyro/tilt position sensors. The device is then upgrading its sampling rate to the highest level possible without consuming too much energy for the device battery. Typically such sampling rate can be chosen to be 20 samples/sec or higher. In stage 412 the device is initiating the highest sampling rate of the gyro based or other angular tilt sensor fast sampling mode and in parallel in stage 414 the device is initiating its fast acceleration measurement sampling mode using its integrated accelerometer sensor. In stage 416 the state machine .shows the operation wherein the device SW is uploading the original user movement measured data recorded and stored doting the initial stage of the legitimate device owner/user. In stage 418 the state machine shows the actual authentication phase execution by comparing the movement results of the user hand holding the device to the stored user's hand movement recorded data collected during the user's initial enrollment stage. Stage 420 is a decision stage of the state machine by comparing the #D movement graph shape of the user to the shape done and recorded in the enrollment initial phase. If comparison results show a big deviation between the 3D movement recorded graphs, then the state machines moves to stage 424 when device full alarm display and sound generation mode is activated. If movement shape of the enrolment data file and the present user movement data file are matching above a predefined threshold, then the state machine is moving to stage 422 wherein comparing the measured results of the movement velocity and/or acceleration and/or tilt match between the present user hand movements and the registered set of user' original enrollment process movement velocity and/or acceleration and/or tilt is done by the service SW. If the results show no match the state machine moves to stage 424 and activates alarm as well. If comparison done on stage 422 show good match above a predefined SW driven matching threshold, then the device CPU move the state machine state 428 wherein the device SW stating full user's authentication is approved and all the device functional operations are unlocked and the user can use the phone for all its available functions. Stage 426 is activated as a final conclusive stage of a non-legitimate user no authentication stage, wherein the user is defined by the device as a non-legitimate user trying to still or use the device with no authorization. In such a case 426 the device sends an alarm by a text message (SMS or WhatsApp message) to a dedicated security or remote multiple users status and security monitoring center and in parallel sending a similar alarm and theft warning message is automatically sent to other registered users or recorded contact details of friends of the legitimate device owner.

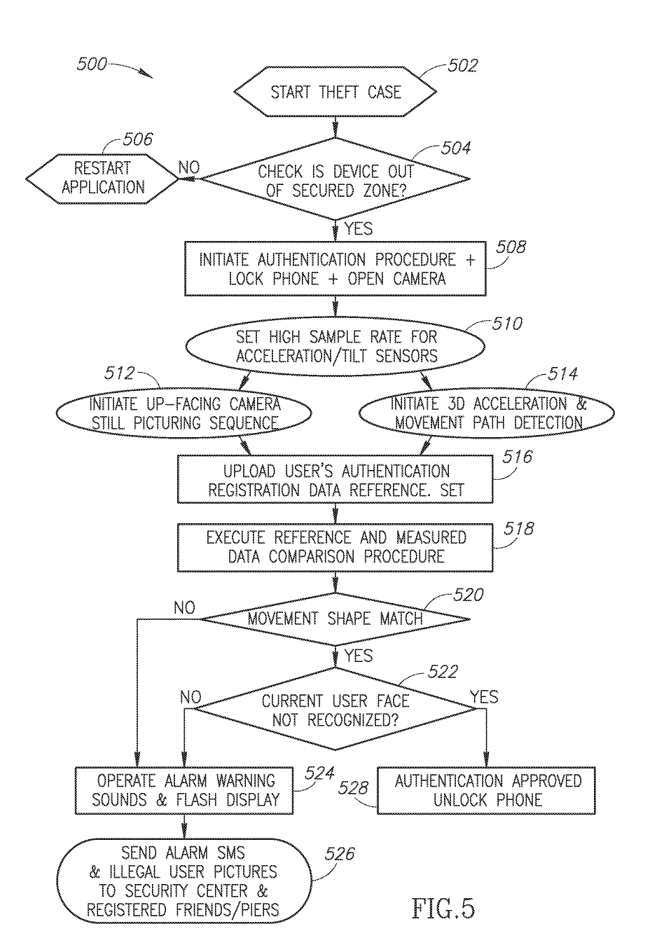

Reference is now made to FIG. 5 is a schematic illustration of a state machine wherein states reflect actions and transition arrows relate to external triggers which are performed with regard to a certain layout, according to one embodiment of the present invention, wherein this state machine is demonstrating the different change states of the present invention theft secured mobile device 100, and wherein the flowchart 500 is representing the user's authentication and possible alarm activation phase of the devise when the authentication process is initiated where the device is not situated in what was predefined by its user as a secured zone where no alarm activation is required in any event. Stage 504 is the starting point in the activation of the state machine of the SW, activating the device according to its momentary position. In stage 504 the device is checking its position coordinates by using its integrated GPS or reading the Google positioning services data to analyze and define if its location is in a safe zone or not. This safe location state is related to being in protected and trusted pre-defined user's/device location zone, like home, family, or work place. If location is found to be in a safe zone it moves to stage 506 were the device is safe open for all available device uses and waits for change in location or activation of authentication by the user. If the location assessment in 504 finds the device to be in a non-secured zone it moves to stage 508 where automatically it starts requesting the user/holder to do an authentication by his hand movement based action and in parallel it is locking and blocking the mobile device communication and other operational capabilities by the automatically firing of the procedure described in FIG. 4 related state machine steps and the related device SW configuration In case the device location is not a user's defined safe zone. In this device operational and functional present invention embodiment the device is also automatically activating in stage 512 the camera embedded within the device case and facing the suspected user's face. To enable higher accuracy measurement of the device accelerometers and gyro/tilt position sensors. The device is then upgrading its sampling rate to the highest level possible without consuming too much energy for the device battery. Typically such sampling rate can be chosen to be 20 samples/sec or higher. In stage 510 the device is initiating the highest sampling rate of the gyro based or other angular tilt sensor fast sampling mode and in parallel in stage 514 the device is initiating its fast acceleration measurement sampling mode using its integrated accelerometer sensor.

In parallel, in stage 512 the device is initiation a sequence of exposures of the integrated camera caching the user in order to accumulated maximum visual data on the face recognition of the evaluated user. In stage 516 the state machine .shows the operation wherein the device SW is uploading the original user movement measured data recorded and stored doting the initial stage of the legitimate device owner/user. In stage 518 the state machine shows the actual authentication phase execution by comparing the movement results of the user hand holding the device to the stored user's hand movement recorded data collected during the user's initial enrollment stage and comparing the main facial features of the photographed user to those stored in the device during enrolment. Stage 520 is a decision stage of the state machine by comparing the 3D movement graph shape of the user to the shape done and recorded in the enrollment initial phase. If comparison results show a big deviation between the 3D movements recorded graphs, then the state machines moves to stage 524 when device full alarm display and sound generation mode is activated. If movement shape of the enrolment data file and the present user movement data file are matching above a predefined threshold, then the state machine is moving to stage 522 wherein comparing the measured face recognition main features of the users photographed face between the present user imaged face and the registered set of user' original enrollment process face image main features used in face recognition. If the results show no match the state machine moves to stage 524 and activates alarm as well. If comparison done on stage 522 show good match above a predefined SW driven matching threshold, then the device CPU move the state machine state 528 wherein the device SW stating full user's authentication is approved and all the device functional operations are unlocked and the user can use the phone for all its available functions. Stage 526 is activated as a final conclusive stage of a non-legitimate user no authentication stage, wherein the device as a non-legitimate user trying to still or use the device with no authorization defines the user. In such a case 526 the device sends an alarm and the face pictures of the suspected an authorized user by a text/image message (SMS or WhatsApp message) to a dedicated security or remote multiple users status and security monitoring center and in parallel sending a similar alarm, suspect thief images and theft warning messages are automatically sent to other registered security supporting users, or recorded contact details of friends of the legitimate device owner.

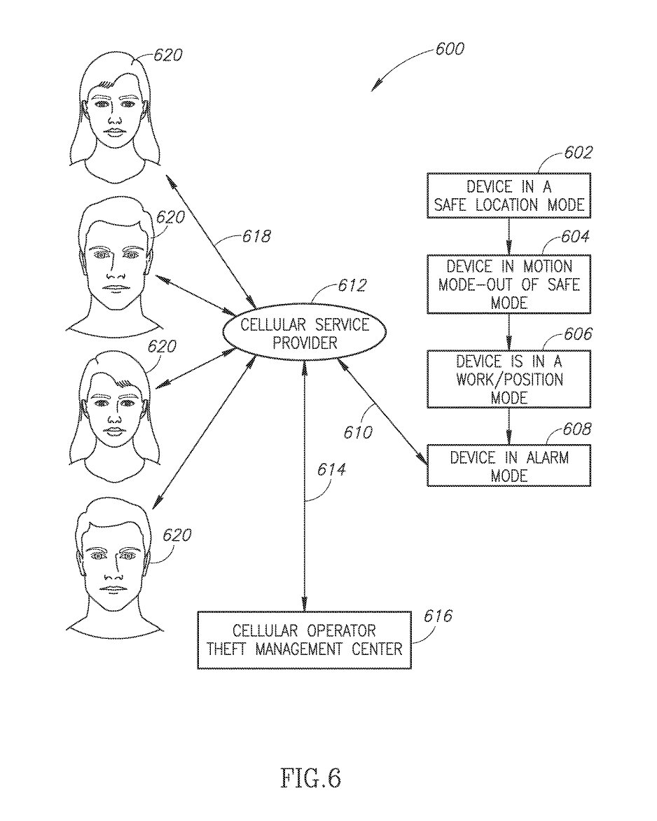

Reference is now made to FIG. 6. is a flowchart of the modes of operation of the present invention device as part of an any theft management system. In block 602 it shows the state of the device being in a safe location mode where no alarm is generated and no prior authentication process is requested from any user holding the device. In block 604, the sensors in the device are sensing that it is moving out of the geographical region defined by the device owner as a safe location area. Following a short delay when the devise is evaluating if the movement is significant or not and the device stays in an non safe location the device status is defined under block 606 were the devise alarm ready for operation mode is triggered, waiting to sense and evaluate any new event when a user will move the device while the device is situated in a non-safe region. In block 608 the device has sensed any movement out of a still position and if it will not be able to authenticate the user moving the device, it will create an alarm. In parallel it will send via the cellular data transmission network 610 a message to the cellular service provider servers 612, stating that the specific user mobile device is under danger of being stolen or misused. The alarm warning message received and the cellular service provider center will be automatically forwarded as an emergency message to a cellular operator special theft management service center 616. The cellular service provider server 612 will forward a data message with information about the number, owner name, location and suspected thief face picture to a group of the user's piers that will help to catch the thief and return the device to it legitimate owner.

What is claimed is:

1. A mobile electronic device comprising:
a. at least one movement measuring set of sensors module generating a three dimensional coordinates measured data signal representing a user's 3D hand motion in space by creating a set of sampled data combined of a segmented movement pattern sequence of said devise, while said user up lifting moving and holding said mobile devise from its original stationary position;
b. an electronic software activated lock/unlock circuit for enabling operation of one or more alarm and emergency functions and for inhibiting communication functions of said mobile electronic device in response to said sensors module 3D movement measured and sampled signal sequence analysis results;
c. wherein said lock/unlock and alarm triggered set of functions activation and operation is executed when a user sampled data sequence of said user preferred 3D motion pattern while lifting and holding said device, is compared to a similar prerecorded and stored on said devise set of sampled reference data sequence profiling the three dimensional legitimate user's hand motion pattern in space, said prerecorded sampled reference data is recorded upon the legitimate user executing on said devise an initial registration motion pattern recording process; and
d. said alarm is activated while an illegitimate devise user is lifting said device from a stationary position, wherein the measured movement data when compared with the reference legitimate user recorded reference ID data deviates from each other by more than a predetermined threshold.

2. The mobile electronic device of claim 1, wherein said at least one movement measuring set of sensors is selected from the sensors group including a three dimensional linear acceleration measuring sensor and a three dimensional angular tilt measuring sensor; and wherein said tilt sensor module is generating a three dimensional tilt angles sampled signal vector representing said devise user's up-lifting and holding palm and hand maneuvering angular motion in space.

3. The mobile electronic device of claim 2, wherein said three dimensional linear acceleration signal vector results and said measured three dimensional tilt angles sampled signal vector results, are fused together by using a learning and adaptable dynamically weighted factor fusion algorithm between said two sensors measured output, in order to enable improved and precise analysis and identification of the exact typical personal characteristic space movement of said user's palm and hand, while uplifting and holding said electronic devise; and wherein said algorithm is creating a highly reliable user's authentication mechanism to decide, while comparing to a similar reference prerecorded fused set of said two kinds of sampled user's hand motion characterizing data, if to activate said lock/unlock circuit for enabling operation of one or more emergency functions of the mobile electronic device.

4. The mobile electronic device of claim 2, wherein a. said mobile devise further comprises:
an integration module for integrating said measured acceleration signal data with respect to time to generate a velocity signal data and a displacement signal data; and an executable authentication process for comparing a representation of the 3D displacement signal data and the 3D velocity signal data in addition to said acceleration reference data to the reference pre-recorded motion data, said reference motion data comprising reference 3D displacement data and reference 3D velocity data in addition to said acceleration reference data; and
said integration module enabling enhanced precision operation of the comparison and analysis of said user's authentication movement analysis function results, while 3D moving said mobile devise if the sampled representation of the displacement signal and the velocity signal and the acceleration signal data deviates by more than a predetermined threshold from the reference sampled displacement set of pre-recorded displacement data and velocity set of prerecorded data and acceleration signal set of the device legitimate owner prerecorded registration stage data.

5. The mobile electronic device of claim 2, wherein said mobile devise further comprises:
a data processing module for creating the first and a second derivative of the 3D measured tilt signals with respect to time to generate an angular velocity signal and a an angular acceleration signal; and
a. said mobile devise further executing a learning weighted factors fusion algorithm for creating the combined and dynamically weighted representation of the measured 3D displacement signal, the 3D velocity signal, said 3D acceleration data, fused together with a weighted representation of said measured 3D angular data, the measured 3D angular speed signal and the 3D measured angular acceleration data, to the reference pre-recorded motion data; and
b. executing an authentication process for comparing said presently measured 3D movement data with said devise stored reference motion data comprising activating said weighted factors fusion algorithm on said reference 3D displacement data, said reference 3D velocity data, said reference 3D acceleration data, said reference 3D angular data, said reference 3D angular speed data and said 3D angular acceleration data; and
c. further enabling operation of the lock/unlock function of said mobile electronic device if said authentication process shows that said measured and fused combined weighted representation of said user hand movement data deviates from said fused reference motion data by more than a predetermined threshold.

6. The mobile electronic device of claim 2, wherein said reference motion data represents said device legitimate user's required N times sampled and continually averaged pre-recorded 3D up-lift hand movement pattern of said mobile devise, when it is moved from its stationary steady state position, either when said devise is lying on a resting surface or taken out from a continuous and repetitive motion movement pattern when carried on a user's body, or when it is uplifted from a carrying bag and the user's motion represent the user momentary uplifting 3D movement pattern of said electronic device from its present resting surface, or from its continuous and repetitive movement pattern when said device is carried on a user's body, or when it is uplifted from a carrying bag.

7. The mobile electronic device of claim 1: further comprising:
a. a dedicated secured soft key switch for user's activation/deactivation control of said mobile electronic device electronic software, which in case of a false user's authentication activates a lock/unlock alarm circuit enabling said operation of one or more emergency functions of the mobile electronic device;
b. wherein a user intervention free self-triggered activation of the lock/unlock function ready for use devise status is enabled only after an N user defined minutes of said mobile device being in a stationary position status or after an M user defined minutes, when said devise is carried by its user in a continuous steady movement sequence of said mobile device;
c. a display unit for indicating status of said mobile electronic device and the display of data; and
d. wherein the a movement activated emergency alarm function of said mobile electronic device enabled by said lock/unlock circuit, comprises at least one function selected from a group of said mobile devise anti-theft and loss related functions, including at least : i) setting up a highly audible audio alarm signal through said electronic device having integrated audio signals generation capabilities; and ii) generating a display function of said display unit indicating and alarming by display light and image flashing and displaying fixed combination of text, graphics and icons of the lifting and moving event of said device by an illegal non registered user.

8. The mobile electronic device of claim 1, further comprising a camera module, a frame grabber and a face recognition module, wherein said face recognition module output data is fused together under an authentication software module with said movement sensor module output data to create a more precise authentication quality of said devise legitimate owner while said user is lifting said mobile device from its rest position.

9. The mobile electronic device of claim 1, further comprising:
a. a wireless transmission module for the exchange of wireless data signals between said devise and a remote system;
b. a software operated self triggered switch for a suspected theft event generating a control signal of said mobile electronic device for preparing and sending said device user data and said device momentary location to said remote system;
c. a display unit for indicating status of said mobile electronic device and display of data received from said remote system; and
d. wherein the function of said mobile electronic device enabled by the activation of said lock/unlock circuit related to said exchange of wireless data signals between said devise and said remote system comprising the transfer of at least:
i. an alarm indication;
ii. said mobile devise momentary geographical location; and
iii. an emergency generated data set containing said device and legitimate user identifying data, transmitted to said remote system through a wireless digital data message.

10. The mobile electronic device of claim 8, further comprising:
a. a software module containing a registered list of said devise user close group of persons and their direct access communication data; and
b. said software module sending said group of persons alert messages including said mobile devise momentary location, in case of an emergency case, such as when said devise senses that a suspected theft event has occurred.

11. The mobile electronic device of claim 8, further comprising;
a. a software module activating and operating automatically said device integrated facing up camera module together with said device lighting assistance flash light modules, said camera trigged to take a slide when said devise is up-lifted from its resting position by a non-authenticated user; and
b. sending said non authenticated predefined size set of user's pictures created under a serial sequence of user's face image frames and transferring said serial sequence or a selected part of it to said remote system and to said list of phones of said close persons. Sending to said close friends alert messages including said suspected theft devise momentary location, its theft alert message and said devise continuous sequence of pictures, in case of an emergency case like said devise theft has occurred.

12. The mobile electronic device of claim 10, wherein the reference motion data that represents the device legitimate user upon said device initial enlisting process includes said device recorded uplifting 3D sampled motion pattern and the user motion represents the present user moving the electronic device in a selected pattern in space while uplifting the device in a typical user selected registration hand motion.

13. The mobile electronic device of claim 1, operating as a user's authentication client to a remote service provider system, said mobile electronic device further comprising:
a. a wireless transmission system exchanging wireless data signals with a remote service provider system;
b. an acceleration 3D movement sensor module generating a 3D acceleration signal representing said user motion in space while uplifting and holding said mobile electronic device; and
c. an authentication sub-system comprising an executable authentication process for executing an authentication request call generated by said remote service provider system transmitted to said mobile electronic device via wireless signal; and then said mobile devise returning an authentication confirmation created by a representation and processing in said mobile device of the measured 3D acceleration signal, back to the remote service provider system.

14. The mobile electronic device of claim 12, further comprising an integration module for integrating the measured acceleration signal with respect to time to generate said mobile device velocity signal in time and an associated displacement signal; and the representation and the processing of said devise movement signal is based on fused processing the results of the measured acceleration signal together with the calculated velocity signal and the displacement signal.

15. The mobile electronic device of claim 6, further comprising a second dedicated secured soft key switch for user's deactivation control of said mobile electronic device electronic already activated lock/unlock alarm circuit enabling one or more emergency functions of said mobile electronic device, wherein activating said second soft key enables the user to select at least one of one of the following alarm deactivation functions:
i. said user is requested to feed in his pre-registered user name and password into displayed blank spaces appearing in said device screen once said second soft key is activated by said user; and
ii. a voice data processing module is activated by said second soft key activation on said mobile device, wherein at that stage a human voice activated question is played to the user and then waiting to be vocally shortly responded by said legitimate user voice, wherein said activated voice question is randomly selected from a set on N user's personal self-selected data set of questions stored in said mobile device memory together with the associated expected user true answers response.

16. The mobile electronic device of claim 1, further comprising:
a. a Bluetooth transceiver data communication module integrated in said mobile electronic devise;
b. a second RF low radiation level sensitive Bluetooth mobile transceiver pocket size sensor device, encased in a compact package and normally connected to said user set of private access and door locks key holder, or installed in said user hand bag or briefcase; and
c. wherein said second device is activating said lock/unlock alarm triggered set of functions in said first mobile devise, whenever the communication distance between said first and said second devise is larger than a pre-defined distance of M meters which is indicated when the associated detected RF communication transmitted and received signal between said first and second devise if lower than a predefined threshold.

17. The mobile electronic device of claim 15, wherein said second RF radiation level sensitive sensor device is a passive RFID sensor back reflecting modulated energy coming from said first mobile devise RF transmitter and reflected back to said first mobile devise RF receiver.

18. The mobile electronic device of claim 1, further comprising a tilt triggered sensitive module, wherein said electronic software activated lock/unlock circuit for enabling operation of one or more alarm and emergency functions is operating an audio location indication sound in said mobile devise whenever said mobile devise located within a hand carried bag or briefcase is being shaken intentionally by said user along the XY plane, while avoiding executing a significant uplifting movement along the Z axis, in order to enable creation for the user of an audio indication non alarm sound that indicates to its user that said mobile devise is in said hand bag without the user's need to open and check said bag content.

19. The mobile electronic device of claim 1, further comprising an anti-theft reference warning marker visible on an external portion of the housing or on the display of said mobile electronic device, wherein said reference marker indicating and warning potential thieves that said mobile electronic device has a built in anti-theft module and also said warning marker is including a 24/7 phone number to call by the finder, in case of said mobile devise loss.

20. A method of enabling a theft deterrent solution or a loss case protection function for a mobile electronic device, the method comprising:
a. prompting a user to download and register his phone in an anti-theft and loss avoidance software application; and
a. said user recording his personal authentication 3D movement pattern data while uplifting his mobile device and holding the housing of said mobile electronic device and recording said lifting movement pattern characteristics and repeating it N times to do motion pattern averaging ;
b. detecting movement pattern of said mobile electronic device within three dimensions and generating and recording in said devise sampled movement pattern data representing the user hand movements while creating his own 3D gesture while uplifting his mobile device from a platform;
c. enabling operation of a theft warning or a device misuse alarm generation various functions of said mobile electronic device in response to the measured device 3D movement pattern generated signal indicating that the present user motion deviates from said recorded reference motion data stored on said mobile device by more than a predetermined threshold; and wherein enabling further operation of an alarm function of the mobile electronic device comprises:
d. integrating said acceleration signal with respect to time to generate a velocity signal and a displacement signal; comparing a representation of the displacement signal and the velocity signal to the reference motion data stored in the memory of said mobile device, the reference motion data also comprising reference integrated displacement data and velocity data; and
e. enabling operation of said theft deterrent or a loss case protection function of said mobile electronic device if the representation of the displacement signal and the velocity signal deviates from said reference displacement data and velocity data by no more than a predetermined threshold.

21. The method of claim 20, wherein the reference motion data represents a pre-recorded mobile device owner sampled hand gesture 3D motion data while said devise owner uplifting his device with a simple intuitive or a simple 3D special user created hand movement pattern and the user motion represents a user uplifting said electronic device in a movement sensors tracked and sampled motion pattern.

22. A mobile devices theft and loss security management system, implementing a portable electronic device as a user authentication platform for said devise anti-theft detection and user's protection while said devise communicating with a remote service provider security system, said system operational steps comprising:
a. transmitting via a wireless signal, an authentication call registration request by said electronic devise user, initiating said requested authentication registration process, wherein a reference authentication data file is generated by said electronic device legitimate owner operating N number of times a 3D movement measurement based on reading and processing the output of a 3D movement sensors module embedded in said mobile devise to generate a measured and further calculated said legitimate user's palm and devise movement pattern in space while said sampled sensors module output data set representing said devise owner hand movement in an uplifting natural motion of said mobile device;
b. said devise sending via wireless a signal to said remote security system, wherein a false authentication alarm signal is created when said devise if lifted by a non-legitimate user and wherein said false authentication alarm is created following the results in the comparison of the measured device uplifting movement pattern set of sampled movement signals while comparing it to an average of east two of a pre-recorded uplifting set of sampled movement pattern data signals containing sampled signal data made by said device legitimate owner, which is stored in said device memory; and
c. when said service provider receives said wireless message containing said false authentication alarm signal from said electronic device it sends a theft alarm notification of said specific mobile device and it users ID details via short message signal (SMS), emails or via the internet to a prerecorded set of phone numbers stored at said service provider memory containing a preferred relatives and friends contact list of said device legitimate owner.

23. The system of claim 22, further comprising:
a. subject to a user's false authentication event, automatically initiating and processing upon detecting a non-authenticated user event a set of still face photographs followed by executing on said pictures face recognition functions, while implementing for it said mobile devise integrated electronic camera module and processor ;
b. sending said processed non authenticated user face photography and the theft location and other relevant security event's data to said remote service provider security system and storing it there for further recoding, processing and executing theft case related data security management functions; and
c. avoiding operating a local alarm notification on said devise and avoiding sending such alarm to said remote service provider location if said face recognition function results indicate a high match score to a stored face authentication data of said device legitimate owner or of other users combining an additional group of users which are close family and friends, that their face pictures are prerecorded and stored on said devise.
